(19) United States
(12) Patent Application Publication
(10) Pub. No.: US 2016/0205876 A1
(43) Pub. Date: Jul. 21, 2016

(54) IMPROVED SYSTEM AND METHOD OF FELLING TREES

(71) Applicant: JAMES WALTER, FLINT, TX (US)

(72) Inventor: SHANE O. COX, BULLARD, TX (US)

(73) Assignee: JAMES WALTER, FLINT, TX (US)

(21) Appl. No.: 14/914,570

(22) PCT Filed: Sep. 2, 2014
(86) PCT No.: PCT/US14/53708

§ 371 Date: Feb. 25, 2016

Related U.S. Application Data
(60) Provisional application No. 61/872,748, filed on Sep. 1, 2013.

(51) Int. Cl. A01G 23/08

(52) U.S. Cl. CPC A01G 23/08

(57) ABSTRACT

A felling tree system includes a first bag stacked on a second bag, an opening in gaseous communication with the first bag and the second bag, and an escape vent in gaseous communication with the second bag. A method to capture a falling object includes inflating the plurality of separate bags attached to and stacked on each other, channeling air through the plurality of bags via one or more passages, and channeling air through one or more escape vents in communication with air disposed with impact of the falling object.

### TECHNICAL FIELD

The present disclosure relates to felling tree systems and method of use, and more particularly to an improved device and method of use for felling trees in urban areas and other areas in close proximity to buildings, other structures, and sub-surface items.

### DESCRIPTION OF THE PRIOR ART

Felling trees is an age-old necessity and a process well known in the art. While often used for clearing rural land and harvesting forest products, today in urban areas and in other areas where trees are in close proximity to buildings, other structures, and subsurface items, it is often necessary to fell one or more trees for therapeutic or aesthetic reasons.

The ordinary process of felling the entire tree by sawing or cutting with an ax may be impracticable due to space or safety limitations. As a result it may be necessary to fell a tree piecemeal by “topping” the tree and removing it in segments from the top down. This process necessarily generates trunk segments and depending on the age and species of the tree and height of the segment above the ground these trunk segments may weigh in excess of 500 pounds.

It is therefore incumbent on the technician to drop or otherwise lower these trunk segments to the ground below. It may be possible to rig a pulley system to lower them safely, but this is inconvenient because the system must be re-rigged for every segment cut, which it time consuming. Dropping them to the ground is certainly convenient, but nearby structures and concrete appurtenances must be avoided. Also, subsurface items such as sprinkler systems, water lines, septic systems, and the like. This is doubly complex because depending on soil conditions the trunk segments may bounce. Thus, even if the technician cuts carefully and aims properly a nearby or adjoining structure or concrete appurtenance may be struck and damaged. It should be understood, that at a minimum, significant ground damage occurs at impact.

What is needed then is a system and method for quickly dropping heavy trunk segments to the ground without the risk of damage and without leaving unsightly divots in the earth at the base of the tree. It is thus a first object of the invention to provide a system for rapidly transventing a cut tree trunk segment to the base of the tree. It is a second object of the invention to do so in such a way that the tree trunk segment does not bounce and risk damaging nearby structures or concrete appurtenances. It is a third object of the invention to prevent damage to underlying turf or groundcover when felling such a tree.

### BRIEF DESCRIPTION OF THE DRAWINGS

The novel features believed characteristic of the application are set forth in the appended claims. However, the application itself, as well as a preferred mode of use, and further objectives and advantages thereof, will best be understood with reference to the following detailed description when read in conjunction with the accompanying drawings, wherein:

FIG. 1 is an isometric view of a first embodiment of an improved system for felling trees;

FIG. 2a is a cross section view of a first embodiment of an improved system for felling trees;

FIG. 2b is a cross section view of a second embodiment of an improved system for felling trees;

FIG. 3 is an isometric view of a second embodiment of an improved system for felling trees; and

FIGS. 4A, 4B, 5, and 6 are oblique views of a felling tree system in accordance with a preferred embodiment of the present application.

While the system of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the process of the present application as defined by the appended claims.

### DESCRIPTION OF THE PREFERRED EMBODIMENT

The system of the present application will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments may be specifically illustrated in each figure.

In a contemplated embodiment, of the present application, one system includes a multi-air bag, collapsible air bag in the general plan form of a square approximately ten feet on a side. The air bag is approximately four feet in height more or less and is horizontally partitioned internally into multiple air bags. In this embodiment of the present invention there are three air bags, the top two are approximately one foot in height each and the bottom air bag is approximately two feet in height. The topmost air bag is formed with a continuous inflatable wall approximately a foot thick and extending perpendicularly a foot above the top surface of the topmost air bag. It should of course be understood that the dimensions discussed herein are exemplary of one embodiment, and the scope of protection should not hereby be limited to these dimensions.

The air bags internally communicate with one another. Specifically the topmost and middle air bags communicate with each other by means of a series of holes in the partition that separates them. Similarly, the middle and bottommost air bag communicate with each other through a series of holes in the partition that separates them.

The partition between the topmost and middle air bags is tethered to the bottom of the air bag so that it is slightly concave with respect to the other partition and the bottom and top of the air bag. By this means, when the bag is inflated the partition between the topmost and middle air bags retains this concavity and as the falling trunk segment strikes and deflates the topmost air bag and contacts the middle air bag it is drawn to the central area of the partition separating the topmost air bag and the middle air bag.

Arranged about the periphery of each of the top two air bags are a series of exhaust vents. Arranged along one edge of the bottommost air bag is a safety vent. This vent prevents the air bag from rupturing if an overly heavy trunk segment is dropped on the air bag.

In the contemplated embodiment, all the external panels and internal partitions are preferably constructed of 18 ounce vinyl coated polyester fabric. Further, the top surface of the topmost air bag is covered with a protective sheet of 18 ounce vinyl coated polyester fabric. This protective sheet is attached to the top surface of, the topmost air bag by means of attachment points sewn or otherwise attached around the periphery of the top surface where the top surface of the topmost air bag and inflatable walls intersect. This adds a layer of protection to the topmost air bag. Although discussed having these material dimensions and characteristics, it will be appreciated that alternative embodiments could include different dimensions and material qualities.

In use, the air bag is placed at the foot of a tree and inflated by means of a continuously operating electric or gasoline powered blower. The operator working aloft in the tree selects a segment of the tree trunk to remove and executes a kerf cut at the desired point along the tree trunk. The kerf cut is placed on the side of the tree trunk abutting the air bag. The operator next executes a back cut on the side of the tree trunk opposite the kerf cut at a height slightly above that of the kerf cut, and the segment of tree trunk above the kerf and back cut is drawn forward by gravity so that it falls from the tree along a line perpendicular to the long axis of the kerf cut.

By this means the trunk segment lands on the top surface of the air bag, partially deflates the topmost air bag of the air bag, and expends much of its kinetic energy forcing much of the air in the topmost air bag out the exhaust vents arranged around the periphery of the topmost air bag. Slowed considerably, the trunk segment next encounters the middle air bag and similarly forces air out the exhaust vents similarly arranged around the periphery of the middle air bag. By this time the trunk segment has lost most of its velocity and thus kinetic energy and comes to rest at or below the internal partition that forms the top surface of the bottommost air bag.

While heavier logs usually exhibit this type of ballistic behavior, lighter trunk segments have a tendency to bounce slightly on impact. It is these trunk segments that tend to impact the inflatable retaining walls arranged around the periphery of the topmost air bag. These trunk segments are re-deposited in the central aspect of the topmost air bag and are decelerated to a stop as described above.

When the trunk segment has come to a stop, the operator's assistant rolls the trunk segment towards the periphery of the air bag, over the inflatable wall, and onto the ground below.

Obviously, the various air bags and walls that comprise the air bag are partially deflated by this process and the attached blower re-inflates the air bag as the operator above repositions himself as necessary and executes the next series of cuts.

In yet a second embodiment of the present invention, air columns approximately one foot square in cross section and approximately two feet high extend above each corner where two of the four walls formed as part of the topmost air bag meet. Sewn or otherwise attached to the vertical corner of each air column nearest the center of the topmost air bag of the air bag when viewed from the top, are attachment points arranged such that a protective banner or net may be attached to span the open space between each adjoining pair of air columns. Similarly this protective banner or net may be attached to the attachment points used to attach the protective sheet to the upper wall of the top layer of the topmost air bag. This is embodiment is typically used with the lightest trunk segments which have the greatest tendency to bounce. The enclosing protective banners or nets capture these trunk segments and redeposit them into the central aspect of the top layer of the topmost air bag where they are decelerated to a stop as described above.

In the following description, numerous specific details regarding possible componentry are set forth (e.g., vinyl coated polyester fabric, air blowers, Velcro fasteners, etc.) and methods for assembling air cushion safety bags (sewing, sonic welding, etc.) in order to provide a thorough understanding of the invention. Those having skill in the art will recognize, however, that the invention may be practiced apart from these specific details. In other instances, details well known and widely used in the process of manufacturing such bags (e.g., cutting vinyl coated polyester fabric, affixing attachment points to inflatable structures, etc.) and descriptions of miscellaneous components have been omitted, so as not to unnecessarily obscure the present invention. Also, those having skill in the art will recognize that there are an almost unlimited number of equivalent methods of assembling the invention, particularly regarding the number and size of its internal subdivisions and that all such equivalent structures are included in the scope and spirit of the present disclosure.

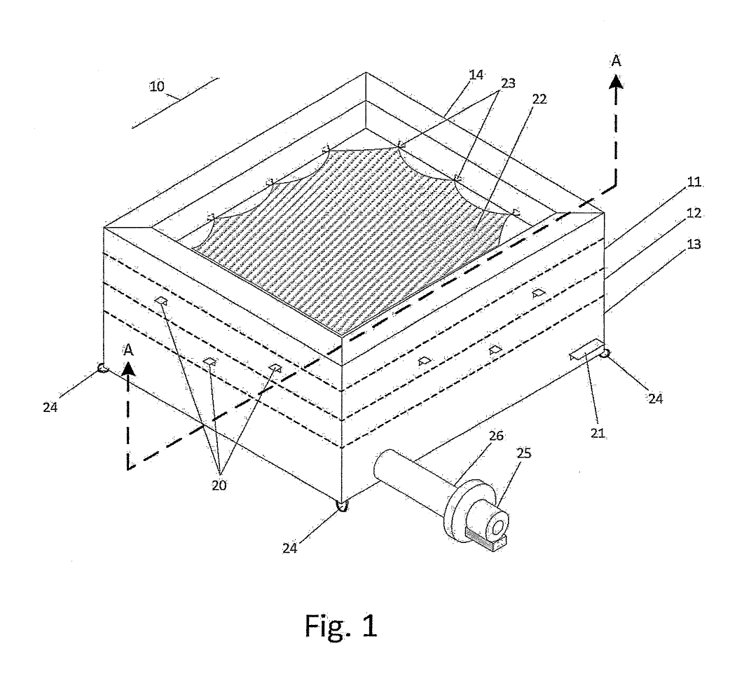

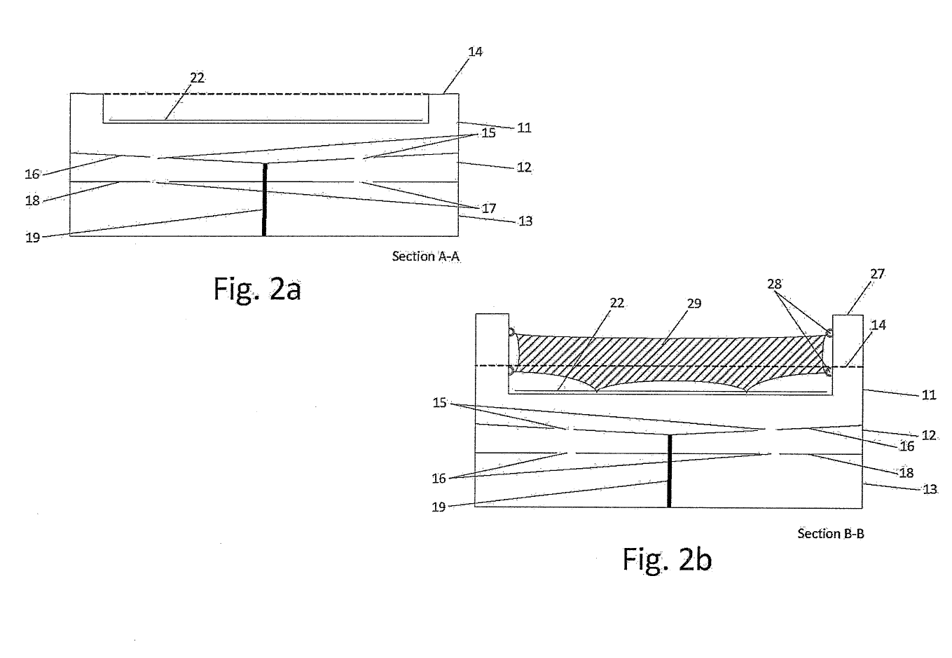

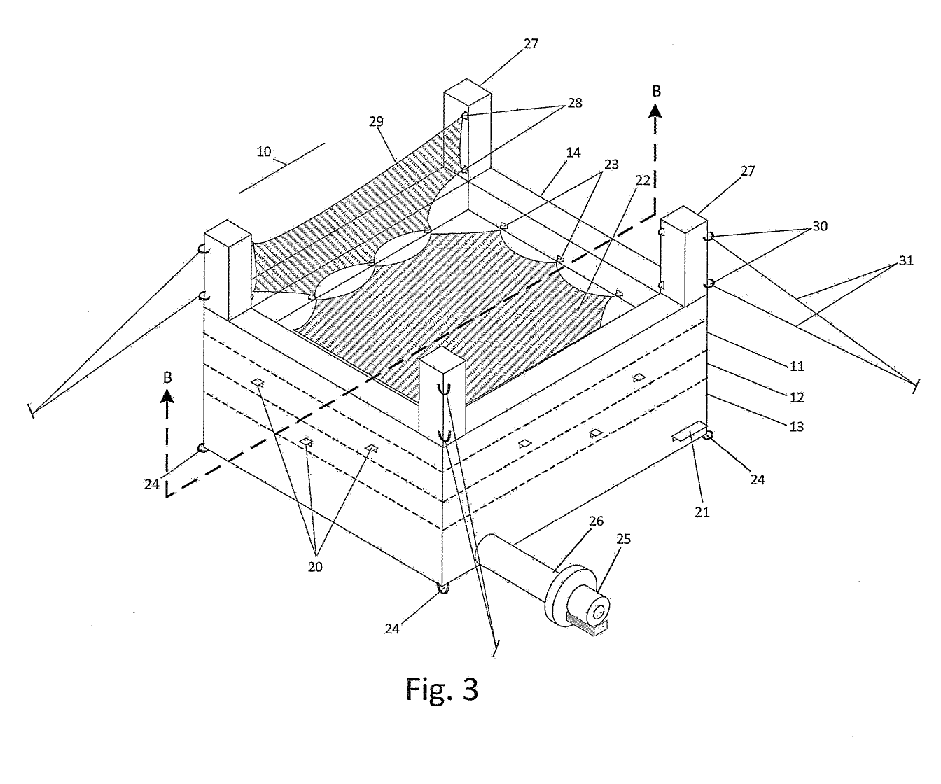

Turning now to FIGS. 1 and 2a, a first embodiment of tree felling air bag 10 is in the general plan form of a square approximately ten feet on a side. It will be obvious to those having skill in the art that such bags may be constructed in virtually any size, however. For example, a similar bag may be constructed in rectangular plan form. Such a bag might be deployed in situations where high prevailing winds causes the impact point of the cut tree segments to be less predictable, for example. Air bag 10 is approximately four feet in height more or less and is horizontally partitioned internally into multiple air bags. In the first embodiment of the present invention there are three air bags 11, 12, and 13. The upper two (11 and 12) are approximately one foot in height and bottommost air bag 13 is approximately two feet in height. Topmost air bag 11 is formed with continuous inflatable retaining wall 14 approximately a foot thick and extending perpendicularly a foot above the top surface of topmost air bag 11 around its periphery.

Air bags 11, 12, and 13 internally communicate with one another. Specifically topmost air bag 11 and middle air bag 12 communicate with each other by means of a series of holes 15 in partition 16 that separates them. In this first embodiment of the present invention three holes 2″ in diameter are provided. Similarly, middle air bag 12 and bottommost air bag 13 communicate with each other through a series of holes 17 in partition 18 that separates them. In this first embodiment of the present invention two holes 2″ in diameter are provided.

Partition 16 between topmost air bag 11 and middle air bag 12 is affixed by means of tether 19 to the bottom of air bag 10 so that it is slightly concave with respect to the other partition and the bottom and top of air bag 10. By this means, when air bag 10 is inflated partition 16 between topmost air bag 11 and middle air bag 12 retains this concavity and as the falling trunk segment strikes and deflates topmost air bag 11 and contacts middle air bag 12 it is drawn by gravity to the central area of partition 16 separating topmost air bag 11 from middle air bag 12.

Arranged about the periphery of each of the top two air bags are a series of exhaust vents 20. Each exhaust vent 20 is constructed of an aperture covered with a flap, such that the flap is blown outward and air is expelled from air bag 10 when receiving a trunk segment, yet the flap remains largely in place covering the aperture when the bag is under constant air pressure from blower 25. In this first embodiment of the present invention there are two exhaust vents 20 on each side of topmost air bag 11 and one exhaust vent 20 on each side of middle air bag 12, each of which is approximately 5″ square. Arranged along one edge of bottommost air bag 13 is safety vent 21. Safety vent 21 also comprises an aperture and a flap, but in this case the flap is held in place by means of hook-and-loop, or equivalent fasteners, thus substantially sealing the aperture. Safety vent 21 prevents air bag 10 from rupturing if an overly heavy trunk segment is dropped on air bag 10. Safety vent 21 does this by opening rapidly when air bag 10 encounters excessively high internal pressure. This quickly and safely vents air bag 10 to the atmosphere. In this first embodiment of the present invention safety vent 21 has an opening of about 20 square inches when the flap opens.

All the external panels and internal partitions of air bag 10 are preferably constructed of 18 ounce vinyl coated polyester fabric. Those having skill in the art will recognize that many different weights of vinyl coated polyester fabric are available ranging from 10 oz. to 30 oz. and that these may be substituted for the preferred weight. However, lighter weight fabric is not as resilient and therefore not as durable while heavier fabric is more durable, yet stiffer, thus causing a greater fraction of trunk segments to bounce undesirably. Further, the top surface of topmost air bag 11 is covered with protective sheet 22 also constructed of 18 oz. vinyl coated polyester fabric.

Protective sheet 22 is attached to the top surface of topmost air bag 11 by means of protective sheet attachment points 23 sewn or otherwise attached around the periphery of the top surface of air bag 10 where the top surface of topmost air bag 11 and inflatable retaining wall 14 intersect. This adds a layer of protection to topmost air bag 11. Different weights of vinyl fabric may be substituted for the preferred 18 oz. fabric generally as discussed above.

In use, the first embodiment of the present invention is placed at the foot of a tree and staked or otherwise secured at the foot of the tree by means of base anchoring points 24. Air bag 10 is inflated by means of a continuously operating electric blower 25 connected to the input vent of air bag 10 by means of duct 26. Those having skill in the art will recognize that numerous commercially available equivalents may be substituted to perform the same function. While the present invention comprehends an electric blower, it will be readily recognized that other types of blowers, including gasoline powered ones, may be used. Moreover, while the input vent of air bag 10 to which duct 26 is coupled is shown communicating with bottommost air bag 13, this need not be the case. The input vent of air bag 10 may communicate with any one or more of air bags 11, 12, or 13.

Next, the operator working aloft in the tree selects a segment of the tree trunk to remove. When using first embodiment of the present invention the trunk segment is normally selected to weigh between about 200 lbs. and about 400 lbs. After selecting a suitable segment, the operator executes a kerf cut at the desired point along the tree trunk. The kerf cut is placed on the side of the tree trunk abutting air bag 10. The operator next executes a back cut on the side of the tree trunk opposite the kerf cut at a height slightly above that of the kerf cut. After properly executing the cuts, the trunk segment above the kerf cut is drawn forward by gravity closing the kerf cut and breaking any residual wood between the kerf cut and the back cut so that the trunk segment falls from the tree along a line perpendicular to the long axis of the kerf cut. By this means the trunk segment lands on the topmost air bag 11 of air bag 10 with its overlying protective sheet 22. The trunk segment partially deflates topmost air bag 11 of air bag 10, and expends much of its kinetic energy forcing most of the air in topmost air bag 11 out of exhaust vents 20 arranged around the periphery of topmost air bag 11. Slowed considerably, the trunk segment next encounters concave partition 16 forming the upper wall of middle air bag 12 and similarly forces air out of exhaust vents 20 similarly arranged around the periphery of middle air bag 12. By this time the trunk segment has lost most of its velocity and thus kinetic energy and comes to rest at or below partition 18 that forms the upper wall of bottommost air bag 13.

While heavier trunk segments typically exhibit this type of behavior, lighter trunk segments have a tendency to bounce slightly on impact with topmost air bag 11. It is these trunk segments that impact inflatable retaining wall 14 arranged around the periphery of topmost air bag 11. Inflatable retaining wall 14 re-deposits these trunk segments into the central aspect of topmost air bag 11 where they are decelerated to a stop as described above.

When the trunk segment has come to a stop, the operator's assistant rolls the trunk segment towards the periphery of air bag 10, over inflatable retaining wall 14, and onto the ground below.

The ground to further stabilize air bag 10 and air columns 27. The user then attaches protective banner or net 29 between one or more adjoining pairs of air columns 27 by securing protective banner or net 29 to the appropriate banner attachment points 28 and protective sheet attachment points 23. In the exemplary embodiment, a plurality of loops 30 could be secured to the columns and secured to the ground via lines 31.

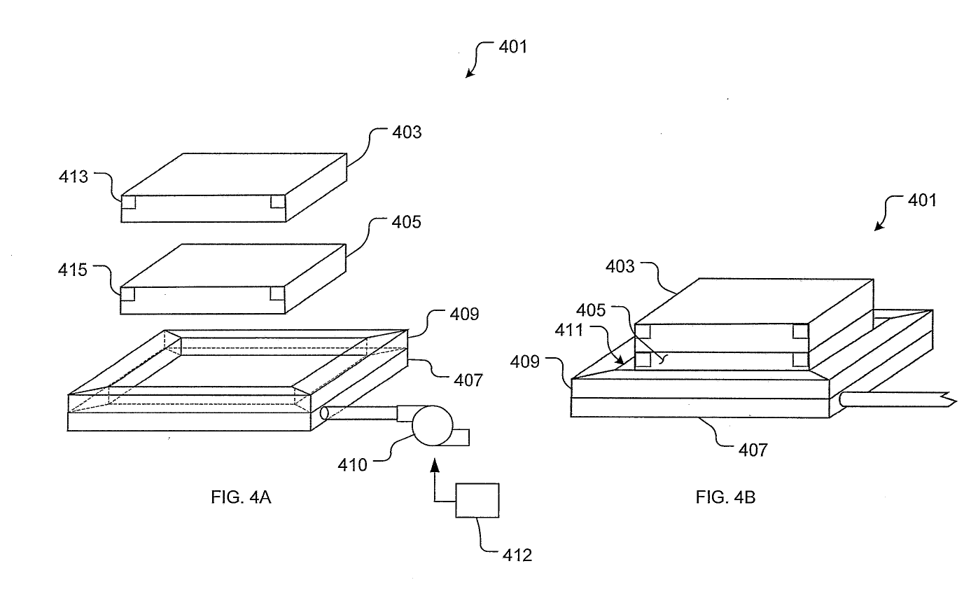

Referring now to FIGS. 4A and 4B in the drawings, respective exploded and assembled oblique views of a felling tree system 401 is shown in accordance with an alternative embodiment of the present application. It will be appreciated that system 401 is substantially similar in form and function to one or more of the systems and devices discussed above and incorporate the features discussed above, and vice-versa.

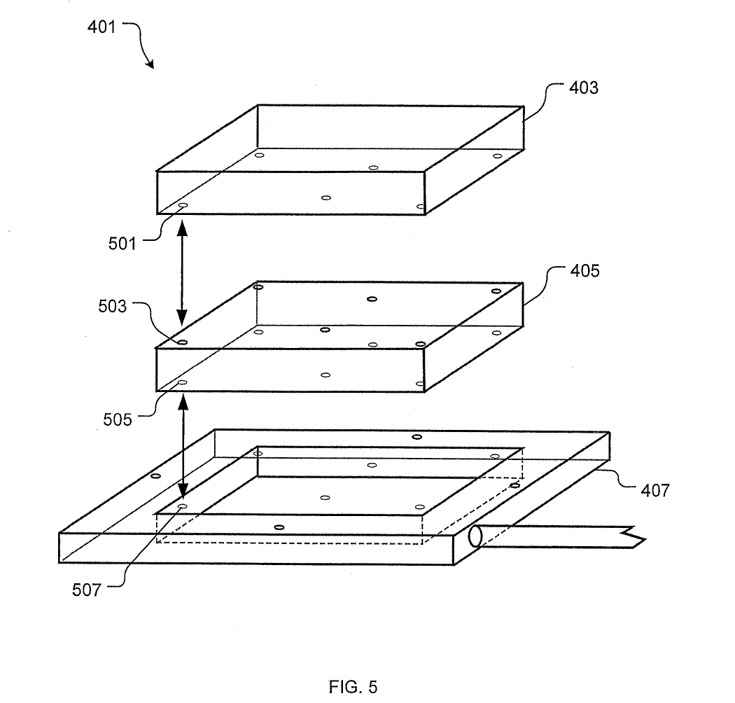

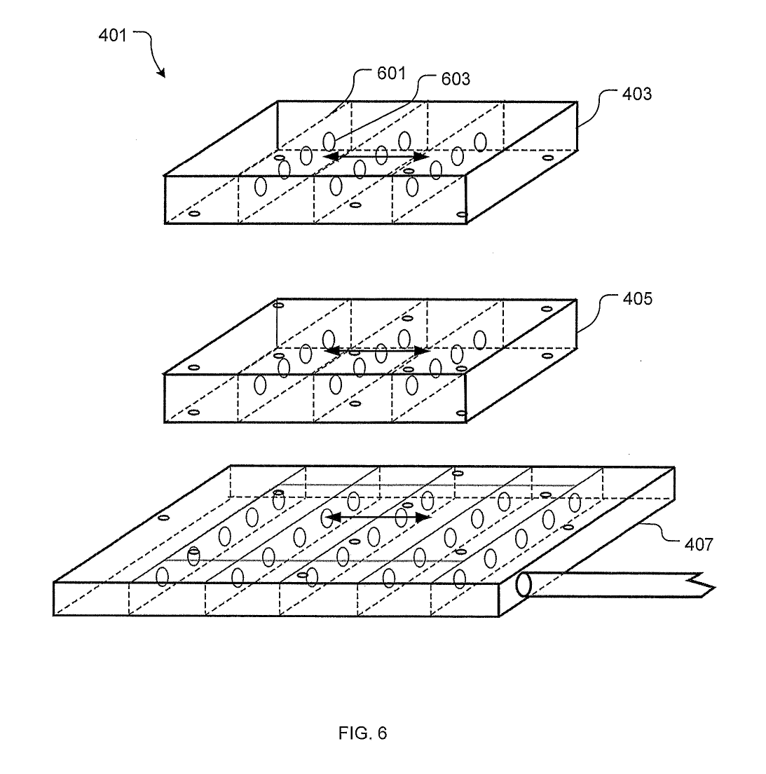

Felling tree system 401 includes one or more of a first air bag 403 that securely fastens to a second air bag 405. Both bags 403, 405 rest on a third support bag 407 that retains the bags 403, 405 in a fixed position during use. As discussed more fully below, air enters bag 407 and travels within bags 403, 405 via one or more passages (see, e.g., FIG. 5) and within the bags themselves via one or more baffle holes (see, e.g., FIG. 6).

It will be appreciated that bags 403, 405, and 407 are effective cushioning means for a falling impact object, e.g., a tree limb, to fall thereupon and to prevent damage to the ground surface and/or underground objects, e.g., sprinkler lines. To achieve this feature, the air is configured to pass through the different bags and escape through one or more escape vents 413, 415 positioned on the sides of the bags and in gaseous communication with the air disposed within the bags.

One of the unique features believed characteristic of the present application is the use of adjustable escape vents 413, 415 to slow the moving object from the falling speed. Thus, air is forced through the escape vents 413, 415, which in turn create the cushioning effect of the air bags. In the contemplated embodiment, the escape vents 413, 415 are flaps configured to cover an opening extending through the thickness of the bag wall. The flaps are that are secured to the bag wall via a fastener, which in the contemplated embodiment is a hook-loop fastener. However, it is also contemplated using other fastening means such as clips, clamps, magnets, quick-release devices, and other similarly suitable devices that secures the flap to the outside wall and which are configured to allow the air to escape the bag as the bag gradually deflates with pressure applied thereto.

In the preferred embodiment, the escape vents are adjustable, thereby allowing a predetermined amount of airflow to pass therethrough. This feature provides significant advantages, namely, the user is able to adjust the rate that the air bags deflate to accommodate falling objects of different size and weight.

Referring back to the drawings, an outer wall 409 is securely fastened to and peripherally surrounds to upper surface of bag 407. During use, wall 409 is configured to remain inflated as an object lands on bags 403, 405. The wall 409 is used to prevent the falling object from bouncing or rolling off the bags, thus wall 409 remains inflated while the other bags deflate via the escape vents. As depicted in FIG. 4B, a gap 411 is formed between the wall 409 and the bags 403, 405, which in turn is used to further prevent the rolling or bouncing of the landing object.

System 401 is further provided with a fan 410 operably associated with a control system 412. When used, the airflow from fan 410 is controlled and adjusted with system 412. This feature provides significant advantages, specifically, the controlling of the airflow entering into the bags allows the user to adjust the impact resistance for falling objects having different weights and sizes.

Referring now to FIGS. 5 and 6 in the drawings, exploded views of system 401 are depicted. In these figures, the inner components of system 401 are illustrated to further illustrate the airflow channeled through the bags. As depicted with a plurality of arrows, the air flows between the bags and within the bags themselves via a plurality of openings.

In FIG. 5, the bag 403 includes a plurality of vent openings 501 in gaseous communication with a plurality of upper vent openings 503 of bag 405, while bag 407 includes a plurality of vent openings 507 in communication with vent openings 505 of bag 405. As depicted with the arrows, the air is channeled to each bag via the vent openings.

In FIG. 6, it is contemplated having a plurality of vertical partition walls 601 that form a plurality of inner chambers within each bag. Passing through each chamber is a plurality of baffle openings that allows air passage, as indicated by arrows, between the chambers.

Thus, as depicted in FIGS. 5 and 6, the air flows through the various openings between each bag and between the chambers within each bag. Upon impact, the air travels through the openings and eventually through one or more escape vents 413, 415.

The particular embodiments disclosed above are illustrative only, as the invention may be modified and practiced in different but equivalent manners apparent to those skilled in the art having the benefit of the teachings herein. It is therefore evident that the particular embodiments disclosed above may be altered or modified, and all such variations are considered within the scope and spirit of the invention. Accordingly, the protection sought herein is as set forth in the description. It is apparent that an invention with significant advantages has been described and illustrated. Although the present invention is shown in a limited number of forms, it is not limited to just these forms, but is amenable to various changes and modifications without departing from the spirit thereof.

1. A felling tree system, comprising:
a first bag stacked on a second bag;
a opening in gaseous communication with the first bag and the second bag; and
an escape vent in gaseous communication with the second bag;
wherein the first bag is stacked on the second bag; and
wherein air is channeled to the first bag from the second bag via the opening.

2. The system of claim 1, further comprising:
a third bag sandwiched between the first bag and the second bag and in gaseous communication with the first bag and the second bag.

3. The system of claim 2, wherein the first bag is fixedly attached to the third bag.

4. The system of claim 1, wherein the escape vent is configured to be adjustable.

5. The system of claim 1, further comprising:
an air fan; and
a control system in communication with the air fan;
wherein the control system is configured to manipulate the amount of airflow entering into the second bag.

6. The system of claim 1, further comprising:
a partition wall disposed within the first bag;
wherein the partition wall forms a first chamber and a second chamber.

7. The system of claim 6, further comprising:
a baffle opening passing through a thickness of the partition wall in communication with the first chamber and the second chamber.

8. The system of claim 1, further comprising:
a wall secured to and extending from a top surface of the second bag.

9. The system of claim 8, wherein the wall is configured to remain inflated while the first bag and the second bag deflate.

10. The system of claim 8, wherein the wall is spaced apart from the first bag and forms a gap therebetween.

11. The system of claim 1, further comprising:
a first column and a second column, both attached to and extending from the first bag; and
a net attached to first column and the second column;
wherein the first column and the second column are spaced apart from each other at a distance.

12. A felling tree system, comprising:
a first bag, a second bag, and a third bag secured to and stacked on each other;
a plurality of openings configured to provide gaseous communication between the first bag, the second bag, and the third bag;
a plurality of escape vents configured to open and release the gas passing through the bags as an object falls on the first bag, the second bag, and the third bag; and
a wall extending from the third bag and spaced apart from the second bag;
wherein the second bag is sandwiched between the first bag and the second bag.

13. The system of claim 12, wherein the plurality of escape vents are configured to be adjustable.

14. The system of claim 12, further comprising:
an air fan; and
a control system in communication with the air fan;
wherein the control system is configured to manipulate the amount of airflow entering into the third bag.

15. The system of claim 12, further comprising:
a partition wall disposed within the first bag;
wherein the partition wall forms a first chamber and a second chamber.

16. The system of claim 15, further comprising:
a baffle opening passing through a thickness of the partition wall in communication with the first chamber and the second chamber.

17. The system of claim 12, further comprising:
a first column and a second column, both attached to and extending from the first bag; and
a net attached to first column and the second column;
wherein the first column and the second column are spaced apart from each other at a distance.

18. A method to capture a falling object, comprising:
inflating a plurality of separate bags attached to and stacked on each other;
channeling air through the plurality of bags via one or more passages;
channeling air through one or more escape vents in communication with air disposed with impact of the falling object.

19. The method of claim 18, further comprising:
adjusting the amount of airflow passing through escape vent.

20. The method of claim 18, further comprising:
adjusting the amount of airflow passing through the airbags with a controlled air fan.
